(19) United States
(12) Patent Application Publication
(10) Pub. No.: US 2023/0250684 A1
(43) Pub. Date: Aug. 10, 2023

(54) FURNITURE FITTING

(71) Applicant: Julius Blum GmbH, Hoechst (AT)

(72) Inventors: Norbert SCHERL, Hoechst (AT); Alexander PETERLUNGER, Lustenau (AT)

(21) Appl. No.: 18/132,528

(22) Filed: Apr. 10, 2023

Related U.S. Application Data
(63) Continuation of application No. PCT/AT2021/060384, filed on Oct. 15, 2021.

(30) Foreign Application Priority Data
Oct. 22, 2020 (AT) A 50910/2020

(51) Int. Cl. E05F 1/10; E05F 1/12

(52) U.S. Cl. CPC E05F 1/105; E05F 1/12; E05Y 2800/26; E05Y 2201/474

(57) ABSTRACT

A furniture fitting includes a mounting device for releasably fastening the furniture fitting to one of two furniture parts, an actuating device which can be connected to the other of the two furniture parts and which is mounted so as to be movable relative to the mounting device, an energy accumulator which has a spring element formed from a wire, an the spring element is designed as a coil spring, and a force transmission mechanism by which energy which can be deposited in the energy accumulator can be transmitted to the actuating device. The wire has, in a cross-section normal to a longitudinal axis of the at least one wire, an outer contour which deviates from a circular shape.

### BACKGROUND OF THE INVENTION

The present invention relates to a furniture fitting for movably mounting at least one first furniture part relative to a second furniture part, as well as a piece of furniture with such a furniture fitting.

Corresponding furniture fittings are formed to move a first furniture part relative to a second furniture part, wherein in particular the furniture fitting is formed as a flap fitting for movably mounting a furniture flap relative to a furniture carcass.

Embodiments of furniture fittings known from the state of the art comprise:
at least one mounting device for releasably fastening the furniture fitting to one of the two furniture parts,
at least one actuating device, which can be connected to the other of the two furniture parts and which is mounted movably relative to the at least one mounting device,
at least one energy storage mechanism, which has at least one spring element made of at least one wire, wherein the at least one spring element is formed as a coil spring, and
at least one force transmission mechanism, via which energy, which can be deposited in the at least one energy storage mechanism, can be applied to the at least one actuating device.

Such furniture fittings are used, for example, to move furniture flaps, wherein the energy storage mechanism of the furniture fitting is provided to compensate for a weight of the furniture flap.

In this case, an opening force is exerted by the energy storage mechanism on an actuating device, with the result that the opening movement of the furniture flap arranged on the actuating device is supported by the energy storage mechanism and the user has to use less force, in particular to move heavy furniture flaps.

On the other hand, the energy storage mechanism is also used to exert a closing force on the actuating device during a closing movement of the furniture flap, with the result that the furniture flap connected to the actuating device can be retracted into a closing position and can be pressed against a furniture carcass with a locking force.

Furthermore, such an energy storage mechanism can be and is used to counteract the weight of a furniture flap, for example, with the result that—when this is opened, for example, and let go of by an operator—the furniture flap does not, due to its own weight, pass into a closing movement and possibly strike an operator or hit the furniture carcass.

In many known cases, these energy storage mechanisms are implemented by spring elements, which can be acted on via a force transmission mechanism, for example a lever mechanism, by an energy which is transmitted by the actuating device.

This energy is used to tension the spring elements of the energy storage mechanism, whereby this energy can be stored in the energy storage mechanism and can be transformed into kinetic energy again at a given time by activation, more precisely by relaxation of the spring element.

Conventional spring elements, which are manufactured in high volumes and are thus obtainable at favorable prices, are normally used as spring elements for the energy storage mechanisms. These spring elements have, for example, a wire which is bent or wound cylindrically along a screw contour. It is common in the state of the art that such wires have a circular outer contour in a cross section normal to their longitudinal axis.

An example embodiment of a corresponding furniture fitting follows from the state of the art from WO 2019/091969 A1.

Energy storage mechanisms, which are in most cases implemented by or have spring elements, require a corresponding installation space in order to be able to satisfy the ever-growing requirements for increasingly higher forces.

However, the great desire for as small as possible an installation space of corresponding furniture fittings arises, as in many cases these take up storage space in pieces of furniture and/or even influence the visual appearance of the furniture.

### SUMMARY OF THE INVENTION

The object of the present invention is to increase the energy that can be deposited by and/or energy that can be released by the energy storage mechanism, yet with a compact design and/or even smaller dimensioning of the furniture fitting.

According to the invention, the at least one energy storage mechanism of the furniture fitting has at least one spring element made of at least one wire, and the at least one wire has an outer contour deviating from a circular shape in a cross section normal to a longitudinal axis of the at least one wire.

Such outer contours of the at least one wire deviating from a circular shape can be, for example, oval, elliptical, egg-shaped, polygonal, rectangular, rectangular with rounded narrow sides or trapezoidal.

Due to the shape, deviating from a circular contour, of the outer contour of the wire in cross section, the wire can have a higher cross-sectional area for example, which—as is familiar to a person skilled in the art—leads to an increase in the section moduli with regard to deformations.

The section moduli of a rectangular shape are higher, for example, compared with a circle (with the same outer dimensions), wherein through the design of the outer contour of the wire as a rectangle, the section modulus is increased, yet with constant installation space.

Designs of the outer contour of the at least one wire along a longitudinal axis of the at least one wire with adapted shapes with reference to the loading—such as an S shape, an I shape or also a T shape, for example—are also entirely conceivable.

This increase in the section moduli with the aid of the alteration of the outer contour of the at least one wire significantly influences the spring constant, whereby higher energies can be applied by the at least one spring element or can be deposited in the at least one spring element with constant installation space.

Preferably, the at least one wire has a constant outer contour deviating from a circular shape over a predominant part of its length, preferably over the entire length, in a cross section normal to a longitudinal axis of the at least one wire.

For example, the end windings of the at least one spring element are ground or bent, with the result that the supporting surfaces of the at least one spring element supported with a large area as possible. As large as possible a supporting surface of the at least one spring element can contribute to the fact that forces acting on the at least one spring element are introduced as symmetrically as possible in the operating direction of the at least one spring element, with the result that no asymmetrical deformation of the at least one spring element and/or of the pretensioning of the at least one spring element and/or transverse forces result (which can lead, for example, to buckling of the at least one spring element).

Preferably, the at least one spring element is formed as a coil spring in which the wire is wound or bound in helical form. In the case of the use of coil springs it is particularly advantageous that, due to their geometrical design, predominantly only torsional stresses form on the wire due to tensile or compressive forces on the at least one spring element, whereby in the case of the same dimensions greater load capacities result.

Preferably, the outer contour in the cross section normal to the longitudinal axis has a minimal extent in a first direction and a maximal extent in a second direction perpendicular to the first direction, preferably wherein:
the at least one spring element has a central axis and the first direction is oriented parallel to the central axis; and/or
the maximal extent is greater than the minimal extent by a factor of 1.1 to 1.5, particularly preferably by a factor of 1.25.

Due to the design of the at least one spring element with a greater extent in a second direction, which is directed normal to a first direction, the field of application can be pursued specifically and the wire can be adapted by its outer contour to the corresponding requirements (for example, by taking account of the cases of loading occurring on the wire by considering operating directions of the applied forces).

Specifically in the use of coil springs, which are primarily under torsional stress, it is particularly advantageous if the wire, when viewed in cross section, has a greater dimension normal to a central axis of the at least one spring element than parallel thereto, as due to this special cross-sectional contour the torsional loads can be countered by a higher section modulus.

It is consequently possible thereby in a smaller or shorter installation space of the at least one spring element, preferably of a coil spring, to generate identical or greater spring constants, with the result that the spring can absorb, deposit and emit the same or larger quantities of energy.

Preferably, the at least one spring element is formed as a compression spring. Alternatively, the at least one spring element could also be formed as a tension spring. The differentiation between tension and compression springs is generally effected based on the types of loading.

Preferably, the at least one spring element is formed from a spring steel.

At least one spring guide can be provided for guiding the at least one spring element. Spring guides can be provided to guide the at least one spring element along an axis—preferably in the operating direction of the at least one spring element—with the result that when a force is applied the at least one spring element does not deform transverse to the operating direction and/or possibly buckle.

Preferably, the at least one energy storage mechanism has a plurality of, preferably two, spring elements. Depending on the force applied or the energy to be deposited, the energy storage mechanism can be adapted by a corresponding choice of the number of spring elements.

The at least one spring element can be arranged rotatably on the at least one mounting device.

Preferably, the actuating device has at least one actuating arm or at least one actuating arm nub, which can be connected to an actuating arm extension.

Preferably, the at least one actuating device is mounted pivotably relative to the at least one mounting device about a swivel pin, which preferably runs horizontally in a usage position.

The at least one force transmission mechanism can have at least one pressure piece, preferably a pressure roller, and at least one control contour on which the at least one pressure piece can be or is mounted displaceably, wherein preferably the at least one control contour is formed on the at least one actuating device.

Preferably, the at least one force transmission mechanism has at least one lever, preferably wherein:
the lever is mounted pivotably on the mounting device; and/or
the energy storage mechanism is placed on the lever via an application point, particularly preferably the application point is adjustable relative to the lever by means of at least one adjusting device.

The at least one force transmission mechanism can be formed as a linkage.

Preferably, the furniture fitting has at least one adjusting device, with which energy that can be transmitted via the at least one force transmission mechanism to the at least one actuating device is adjustable, preferably wherein:
a spring pretensioning of the at least one spring element is adjustable by the at least one adjusting device; and/or
the at least one energy storage mechanism is mounted pivotably on the at least one mounting device and is pivotable by the at least one adjusting device relative to the at least one mounting device.

For example, the energy storage mechanism can be mounted pivotably on the at least one mounting device on the one hand, and on the other hand can be pivotable with respect to the force transmission mechanism by the adjusting device, whereby a lever arm of the force transmission mechanism is alterable relative to the energy storage mechanism. Through variation of the transmission (which accompanies the lever arm) by adjusting the lever arm via the adjusting device, the energy that can be introduced into or deposited in the energy storage mechanism and/or can be retrieved from the energy storage mechanism can be varied.

Preferably, the at least one mounting device has a mounting plate, preferably formed at least partly as a housing of the furniture fitting, for releasable fastening to one of the two furniture parts.

Protection is also sought for a piece of furniture with at least one first furniture part, at least one second furniture part and at least one furniture fitting according to an embodiment variant of the invention, wherein the two furniture parts are mounted movably relative to one another via the at least one furniture fitting.

### BRIEF DESCRIPTION OF THE DRAWINGS

Further details and advantages of the invention forming the subject-matter result from the following description of the figures, in which:

FIG. 1 is a perspective view of a piece of furniture,

FIG. 2 is a perspective view of a furniture fitting,

FIG. 3a is a perspective view of a spring element,

FIG. 3b is a detailed view of FIG. 3a, and

FIG. 4 are various cross sections of various embodiments of spring elements.

### DETAILED DESCRIPTION OF THE INVENTION

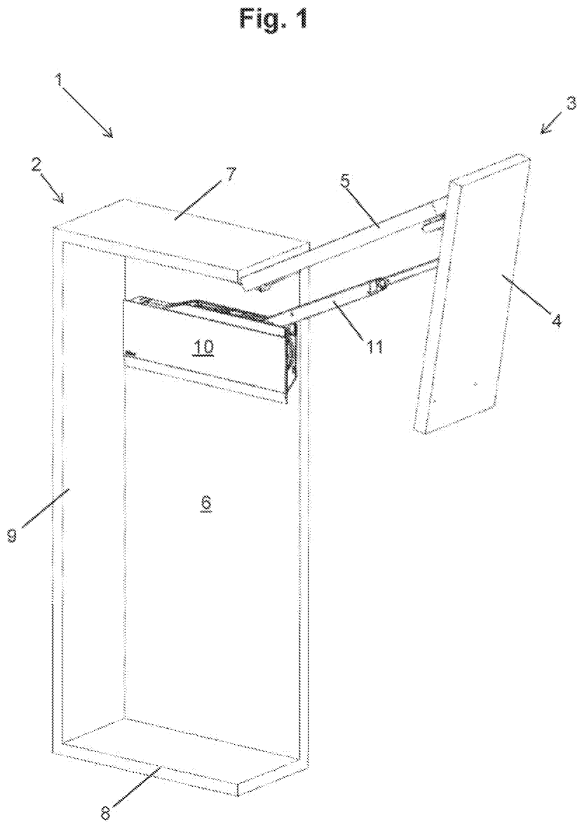

FIG. 1 shows a perspective view of a piece of furniture 1, which has a furniture carcass 2 and a movably mounted furniture flap 3. The furniture flap 3 of this embodiment example is formed from a first furniture part 4 and the further furniture part 5. The furniture carcass 2 consists of a second furniture part 6, a top panel 7, a bottom panel 8 and a rear wall 9.

The piece of furniture represented in FIG. 1 is represented in a section for better illustration of the interior. Through this section it is to be recognized how the furniture fitting 10 is fastened to the furniture carcass 2 and how, via the furniture fitting 10, more precisely the actuating arm 11 of the furniture fitting 10, the furniture flap 3 is mounted movably relative to the furniture carcass 2.

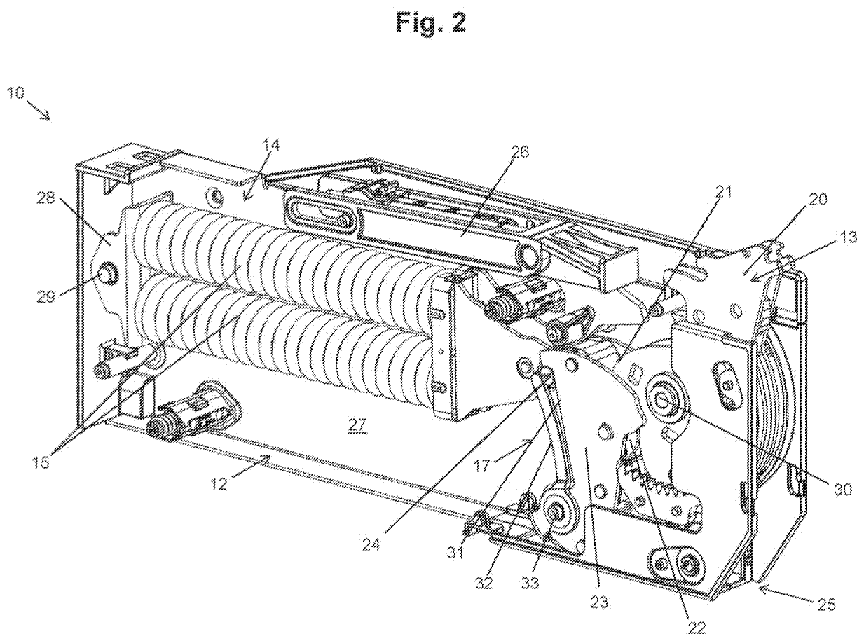

FIG. 2 shows a perspective view of the furniture fitting 10, wherein a cover flap is open in order to reveal the interior of the furniture fitting 10 with its functional elements.

The furniture fitting 10 has a mounting device 12, which is used to be able to attach the furniture fitting 10 releasably to a second furniture part 6. This mounting device 12 in this embodiment example has a mounting plate 27, which is formed as part of a housing of the furniture fitting 10.

A first furniture part 4 can be mounted tiltably relative to the mounting device 12 via an actuating device 13. This actuating device 13 in this specific embodiment example has an actuating arm nub 20, which can be connected to an actuating arm extension attached to the first furniture part 4 in order to form a complete actuating arm 11.

The actuating arm nub 20 of the actuating device 13 is arranged rotatably via the swivel pin 30 on the mounting device 12, more precisely on the mounting plate 27.

The actuating device 13 has (seen towards the swivel pin 30 in the opposing part of the actuating arm nub 20) a control contour 21, which is connected for coherent movement to the actuating arm nub 20. More precisely, the actuating arm nub 20 and the control contour 21 are formed in one piece in this exemplary embodiment and mounted rotatably about the swivel pin 30.

A pressure roller 22 of the force transmission mechanism 17 is mounted or guided on the control contour 21.

The force transmission mechanism 17 of this embodiment example has a lever 23, which lever 23 is mounted pivotably on the mounting device 12.

The already named pressure roller 22, which is guided via the lever 23 on the control contour 21, is arranged on the lever 23.

Due to the guidance of the pressure roller 22 on the control contour 21, the lever 23 is tilted relative to the mounting device 12 when the control contour 21 is rotated about the swivel pin 30.

Due to this tilting of the lever 23 relative to the mounting device 12, the energy storage mechanism 14 linked via the application point 24 to the lever 23 is moved.

During a closing movement of the actuating arm nub 20, the energy storage mechanism 14 is loaded with energy, wherein the energy storage mechanism 14 stores this energy and at the same time a counterforce to the closing movement is transmitted via the energy storage mechanism 14 to the actuating arm nub 20.

Energy can consequently be deposited in the energy storage mechanism 14 via the force transmission mechanism 17.

During an opening movement, this deposited energy of the energy storage mechanism 14 can be released, whereby an opening movement executed by the operator can be supported.

Due to this supporting of this opening movement, the operator does not have to apply the entire force required to lift the first furniture part 4 and it can further be provided that the first furniture part 4 can be held by the energy storage mechanism 14 in any position relative to the second furniture part 6 against its weight, with the result that an operator can safely let go of the first furniture part 4 from outside the end positions of the furniture fitting 10.

The energy storage mechanism 14 is used to apply force to the lever 23 and thus to the actuating arm nub 20 and in this embodiment example has two spring elements 15, which are formed as coil springs, in particular compression springs.

The energy storage mechanism 14 is supported with a first end region on a supporting part 28, which is pivotable about the swivel pin 29. A second end region of the energy storage mechanism 14 is mounted on the application point 24, which is connected to the lever 23.

Via an adjusting device 25 (which is not to be recognized in this embodiment example) the application point 24 of the energy storage mechanism 14 can be locked in place on the lever 23 and a spring pretensioning of the spring elements 15 can be adjusted.

For this purpose the adjusting device 25 has a threaded spindle, which can be actuated by an adjusting tool from the front side (below the actuating device 15). This threaded spindle is mounted on the mounting device 12 and interacts with a corresponding counterpart on the application point 24 of the energy storage mechanism 14 on the lever 23, wherein the application point 24 on the lever 23 is adjustable along a contour 31 of the lever 23.

Through the locking in place of the application point 24 of the energy storage mechanism 14 on the contour 31 of the lever 23, the energy storage mechanism 14 is tilted about the swivel pin 29, whereby a relative distance between the swivel pin 29 and the application point 24 is altered.

Through the alteration of this relative distance, the spring pretensioning of the spring elements 15 can be varied on the one hand and on the other hand a lever arm, which are altered by the force exerted by the energy storage mechanism 14 on the lever 23, whereby the force that can be transmitted via the force transmission mechanism 17 to the actuating device 13 is adjustable.

Through the movement of the application point 24 on the contour 31 of the lever 23, an indicator element 32 is pivoted about the pivot pin 33 relative to the lever 23. This pivoting of the indicator element 32 about the pivot pin 33 is brought about because the application point 24 moves between indicator element 32 and contour 31 of the lever 23 and a corresponding distance between the indicator element 32 and the lever 23 changes. The indicator element 32 can be pretensioned, for example, by a spring element in the direction of the contour 31 of the lever 23.

At a lower end, for example, the indicator element 32 can have an indicator scale, which can be read from outside the housing of the furniture fitting 10 through a corresponding slot in the mounting device 12.

Through the twisting or tilting of the indicator element relative to the lever 23 and thus relative to the mounting device 12, this indicator scale is moved, with the result that for adjusting the energy storage mechanism 14 the indicator scale can be read or observed by an operator from outside via the slot in the housing.

Furthermore, the energy storage mechanism 14 has a spring guide in the interior of the spring elements 15. This spring guide is formed rotationally symmetrical and rests on an inner surface of the spring elements 15, with the result that these spring elements 15 cannot tilt out in a direction transverse to the operating direction when pressure or tension is applied.

The furniture fitting has a damping device 26 for damping the movement of the at least one actuating device 13 in a closing and/or opening direction, wherein the damping device 26 interacts with the energy storage mechanism 14, the force transmission mechanism 17 and the actuating device 13.

The damping device 18 can
be formed as a fluid damper and/or
have at least one piston-cylinder unit and/or
be able to be acted on by the actuating device 13 during a closing movement and/or
be able to be acted on from the same side both during an opening movement and during a closing movement of the actuating device.

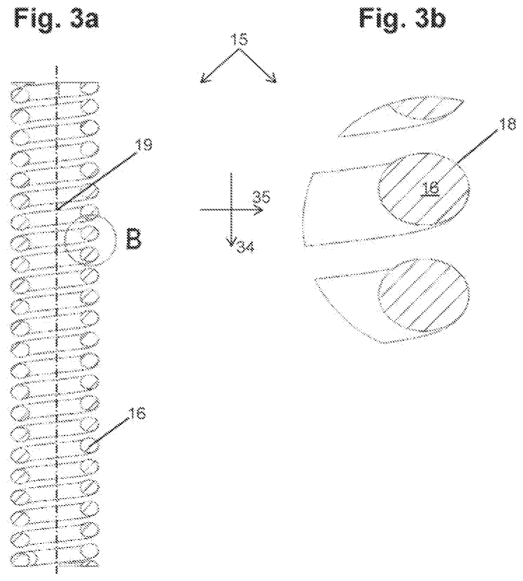

FIG. 3a shows a perspective view of one of the spring elements 15 from the previously named embodiment example, wherein the spring element 15 is represented cut along its central axis 19. FIG. 3b shows detail view B, which is marked in FIG. 3a.

It is thus to be recognized in FIG. 3a how the spring element 15 is formed by a wire 16, which winds or extends along a helical surface around a central axis 19.

This wire 16 is formed along the screw axis (called longitudinal axis of the wire below) with a constant cross section.

Detail B represented in FIG. 3b, which is marked in FIG. 3a, shows the wire 16 in an enlarged representation in a cross section normal to the longitudinal axis of the wire 16.

The outer contour 18 of the wire 16 in this section is formed oval, wherein the outer contour 18 in the cross section normal to the longitudinal axis has a minimal extent in a first direction 34 and a maximal extent in a second direction 35 (perpendicular to the first direction 34), wherein the maximal extent is greater than the minimal extent by a factor of 1.25.

The first direction 34 is oriented parallel to the central axis 19.

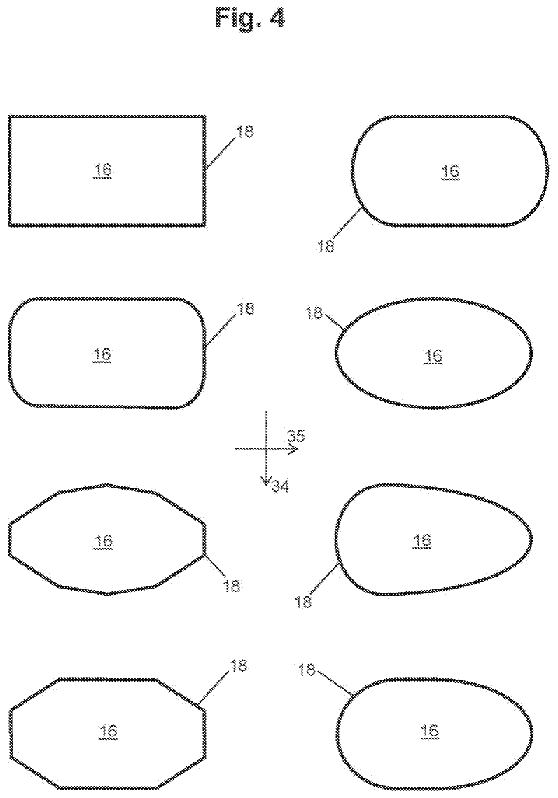

FIG. 4 shows alternative embodiments of wire cross sections of the wire 16, which forms a spring element 15, wherein only the outer contours 18 of the wire 16 (cf. also FIG. 3b regarding this) are shown.

In this FIG. 4, outer contours 18 of the wire 16 are to be recognized, which are rectangular, elliptical, oval, rectangular with rounded narrow side faces, rectangular with rounded corners, polygonal or egg-shaped.

### LIST OF REFERENCE NUMBERS

1 Piece of furniture
2 Furniture carcass
3 Furniture flap
4 First furniture part
5 Further furniture part
6 Second furniture part
7 Top panel
8 Bottom panel
9 Rear wall
10 Furniture fitting

### 11 Actuating arm

12 Mounting device
13 Actuating device
14 Energy storage mechanism
15 Spring element

### 16 Wire

17 Force transmission mechanism
18 Outer contour of the wire
19 Central axis of the spring element

### 20 Actuating arm nub

21 Control contour
22 Pressure roller

### 23 Lever

24 Application point
25 Adjusting device
26 Damping device
27 Mounting plate
28 Supporting part

### 29 Swivel pin

### 30 Swivel pin

### 31 Contour

32 Indicator element

### 33 Pivot pin

34 First direction
35 Second direction

1. A furniture fitting for movably mounting at least one first furniture part relative to a second furniture part, preferably wherein the furniture fitting is formed as a flap fitting for movably mounting a furniture flap relative to a furniture carcass, comprising:
at least one mounting device for releasably fastening the furniture fitting to one of the two furniture parts;
at least one actuating device, which can be connected to the other of the two furniture parts, and which is mounted movably relative to the at least one mounting device;
at least one energy storage mechanism, which has at least one spring element made of at least one wire, wherein the at least one spring element is formed as a coil spring;
at least one force transmission mechanism, via which energy, which can be deposited in the at least one energy storage mechanism, can be transmitted to the at least one actuating device;
wherein the at least one wire has, in a cross section normal to a longitudinal axis of the at least one wire, an outer contour deviating from a circular shape.

2. The furniture fitting according to claim 1, wherein the at least one wire has, over a predominant part of its length, preferably over the entire length, an outer contour deviating from a circular shape, and preferably constant, in a cross section normal to a longitudinal axis of the at least one wire.

3. The furniture fitting according to claim 1, wherein the outer contour is formed oval, elliptical, egg-shaped, polygonal or rectangular with rounded narrow sides.

4. The furniture fitting according to claim 1, wherein the outer contour has, in the cross section normal to the longitudinal axis, a minimal extent in a first direction and a maximal extent in a second direction perpendicular to the first direction, preferably wherein
the at least one spring element has a central axis and the first direction is oriented parallel to the central axis, and/or
the maximal extent is greater than the minimal extent by a factor of 1.1 to 1.5, particularly preferably by a factor of 1.25.

5. The furniture fitting according to claim 1, wherein the at least one spring element is formed as a compression spring.

6. The furniture fitting according to claim 1, wherein
the at least one spring element is formed from a spring steel, and/or
at least one spring guide is provided to guide the at least one spring element, and/or
the at least one energy storage mechanism has a plurality of, preferably two, spring elements, and/or
the at least one spring element is arranged rotatably on the at least one mounting device, and/or
the actuating device has at least one actuating arm or at least one actuating arm nub, which can be connected to an actuating arm extension.

7. The furniture fitting according to claim 1, wherein the at least one actuating device is mounted pivotably relative to the at least one mounting device about a swivel pin, which runs preferably horizontally in a usage position.

8. The furniture fitting according to claim 1, wherein the at least one force transmission mechanism has at least one pressure piece, preferably a pressure roller, and at least one control contour, on which the at least one pressure piece can be or is mounted displaceably, wherein preferably the at least one control contour is formed on the at least one actuating device.

9. The furniture fitting according to claim 1, wherein the at least one force transmission mechanism has at least one lever, preferably wherein
the lever is mounted pivotably on the mounting device, and/or
the energy storage mechanism is linked via an application point to the lever, particularly preferably the application point is adjustable by means of at least one adjusting device relative to the lever.

10. The furniture fitting according to claim 1, wherein the furniture fitting has at least one adjusting device, with which the energy that can be transmitted via the at least one force transmission mechanism to the at least one actuating device is adjustable, preferably wherein
a spring pretensioning of the at least one spring element is adjustable by the at least one adjusting device, and/or
the at least one energy storage mechanism is mounted pivotably on the at least one mounting device and is pivotable by the at least one adjusting device relative to the at least one mounting device.

11. The furniture fitting according to claim 1, wherein the furniture fitting has at least one damping device for damping the movement of the at least one actuating device in a closing and/or opening direction, wherein the at least one damping device interacts with the at least one energy storage mechanism, the at least one force transmission mechanism and/or the at least one actuating device.

12. The furniture fitting according to claim 1, wherein the at least one mounting device has a mounting plate, preferably formed at least partly as a housing part of the furniture fitting, for releasable fastening to one of the two furniture parts.

13. A piece of furniture with at least one first furniture part, at least one second furniture part and at least one furniture fitting according to claim 1, wherein the two furniture parts are mounted movably relative to one another via the at least one furniture fitting.
